(19) United States
(12) Patent Application Publication
(10) Pub. No.: US 2021/0365922 A1
(43) Pub. Date: Nov. 25, 2021

(54) DEVICE CONTROLS

(71) Applicant: Wells Fargo Bank, N.A., San Francisco, CA (US)

(72) Inventors: Harlan H. Bloom, Saint Charles, MO (US); Lizmari Brignoni, Gilbert, AZ (US); Mark David Castonguay, Corte Madera, CA (US); Lisa Munter Clarke, Greenbrae, CA (US); Upul D. Hanwella, San Francisco, CA (US); Traci H. Nguyen, San Francisco, CA (US); Erica Ulrich, San Francisco, CA (US)

(21) Appl. No.: 16/879,588

(22) Filed: May 20, 2020

(51) Int. Cl. G06Q 20/32; G06Q 20/40; G06N 20/00

(52) U.S. Cl. CPC G06Q 20/3265; G06Q 20/405; G06Q 20/4093; G06N 20/00; G06Q 20/3263

(57) ABSTRACT

Systems and techniques for a device controls system are described herein. In an example, a device control system for managing access to personal account data is adapted to receive, from a user device, a set of personalized transaction rules for an account of a user. Each personalized transaction rule may indicate a set of transactional parameters for permitting transactions with a service. The system may be further adapted to receive a transaction request from the service. The transaction request may include contextual data related to the transaction request. The system may be further adapted to determine that the contextual data meets the respective transactional parameters of a personalized transaction rule of the set of personalized transaction rules. The system may be further adapted to transmit, to the service, an indication of permission for the transaction request.

### TECHNICAL FIELD

Embodiments described herein generally relate to regulating access to personal data and accounts, specifically using modeling and contextual information to prevent fraudulent charges.

### BACKGROUND

Many products and services exist that link with a person's personal bank account, such as applications for smart phones and smart watches, which allow for a person to make point of sale payments at retailers or transfer money from one person to another. The introduction of new means for providing financial transactions also introduces new opportunities for fraudulent activities.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a dashboard of an application on a mobile device, in accordance with some embodiments.

FIG. 2 illustrates a dashboard of an application on a mobile device, in accordance with some embodiments.

FIG. 3 illustrates an example of a situational condition for a transaction, in accordance with some embodiments.

FIG. 4 illustrates an example of a machine learning model for transactional conditions, in accordance with some embodiments.

FIG. 5 illustrates a flowchart showing a technique for managing access to personal account data, in accordance with some embodiments.

FIG. 6 illustrates a flowchart showing a technique for managing access to personal account data, in accordance with some embodiments.

FIG. 7 is a block diagram illustrating an example of a machine upon which one or more embodiments may be implemented.

### DETAILED DESCRIPTION

Through the use of applications on mobile connected devices, such as smartphones, new pathways are available for conducting financial transactions. These transactions may include person to person, person to business, or business to business. This is in addition to the already numerous types of online transactions such as online purchases and online bill pay. These are all opportunities for fraudulent activity.

Because there are so many types of financial transactions, it becomes more difficult for financial institutions to detect fraudulent activity, especially prior to completing a transaction. Methods for a client of the financial institution to provide criteria for allowable and non-allowable transactions may assist in preventing fraudulent transactions. Additional access to client activities and routines may provide opportunities for learning allowable and non-allowable transactions based on past performances by the client.

The methods and techniques discussed herein include discussion of an account control system for access to a bank account. It should be understood that the methods and techniques are not limited to accounts such as a checking or savings bank account. This may include a credit card account or funds stored as a gift card or credits with an online retailer. Additionally, the methods and techniques are not limited to monetary transactions but may apply to an exchange of goods or services. The same methods and techniques may apply to access to other forms of data, such as medical records, credit reports, governmental records (i.e., the Internal Revenue Service), and criminal records.

The methods and techniques discussed herein orchestrate personal preferences for multi-level control of an account with a financial institution and how the account interacts with other services. The methods and techniques may further use the personal preferences with contextual data to determine transaction allowances or preventive measures.

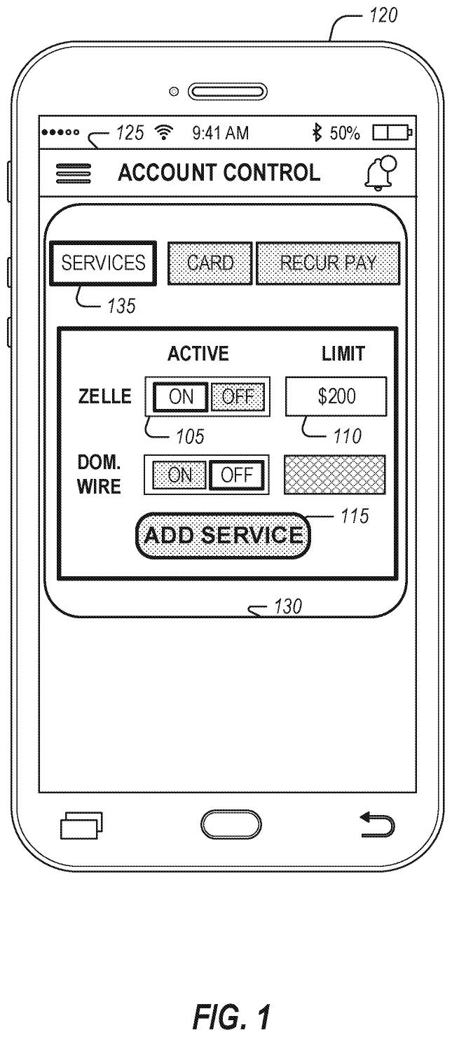

FIG. 1 illustrates a dashboard 130 of an application 125 on a mobile device 120, in accordance with some embodiments. The application 125 may provide access and functions to a user's financial account, such as account balances and performing actions such as transfers. The application 125 may include an account control dashboard 130 for controlling and providing criteria for allowable transactions with different services and vendors. For example, the dashboard 130 includes a tab for services 135, such as wiring money domestically and personal transfer services like Zelle® from Early Warning Services, LLC of Phoenix, Ariz.

A service listed under the services tab 135 may include a toggle switch 105 to indicate if the service is active. For example, when the toggle switch 105 is set to “ON”, then the service is active and transactions that use this service may proceed. When the toggle switch 105 is set to “OFF”, the user has indicated that this service should not be active and any transactions that are attempted with the user's account by this service method are blocked.

Each service listed may include a limit entry 110. When the service toggle switch 105 is set to “OFF”, then the limit entry 110 is inactive. When the service toggle switch 105 is set to “ON”, then the user may input a transaction limit for the service in the limit entry 110. For example, if a limit entry of $200 is entered, then transactions with the service may be allowed if the transaction does not exceed $200. If the transaction requested through the service exceeded $200, the transaction is blocked. The user may leave the limit entry 110 empty to indicate that any transaction amount may be permitted.

The dashboard 130 provides a simplified version of the limit control that may be presented in the application 125. The limit control may include further options such as a transaction total limit for a time period (e.g., day, week, or month). The limit control may include a limit on the number of transactions, without relation to the amount of each of the transactions. For example, a limit of four transaction per day. The limit control may include a geographic limit based on either the location of the user, the location of the recipient, or both. For example, a limit may prevent a transaction that originates outside the user's home state or prevent a transaction where the recipient is outside of the country. The limit control may include a recipient limit or a requester limit, such as the number of recipients for a transaction or the number of transaction requests. The recipient and requester limit may be based on an identification, such that the user may limit transactions and requests to a group of identified people to avoid mistaken or fraudulent transactions. The limit control may include a time of day limit, such as a limit to prevent transaction from midnight to 8:00 AM.

The control dashboard 130 may include an interface mechanic, such as a button, to add an additional service for user control. For example, the control dashboard may include button 115 to “Add Service”. When the user selects the button 115, the user may be prompted for information such as the name of the service and the user's account number or identification for the service. The prompt may include a list of services, such as common or popular services. The service may then be added to the list of services where the user may further customize the settings, such as the toggle switch 105 for being active and the transaction limit in the limit entry 110. For any service the user has not been added, the account control system may default to rejecting a transaction for the service to prevent fraudulent activity. The account control service may send a notification to the user when a transaction request is received from a new or unknown service. The user may then be presented with an option to add the service and allow or prevent further transactions.

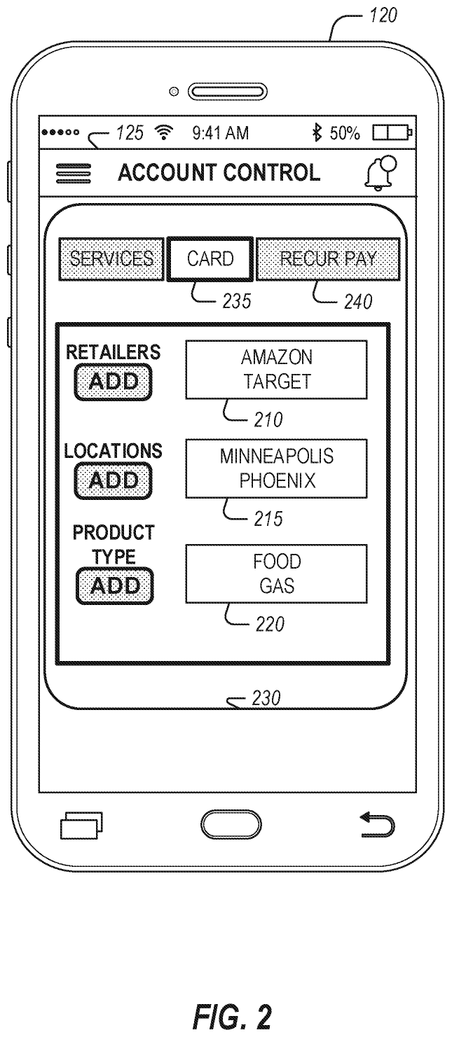

FIG. 2 illustrates a dashboard 230 of an application 125 on a mobile device 120, in accordance with some embodiments. The account control dashboard 230 may provide controls for what types of transactions may or may not be allowed through the account control system. For example, the dashboard 230 includes a tab for a card 235. This may be a type of payment card, like a credit or debit card, associated with the account accessed through the account control dashboard 230.

The card tab 235 may include options for the types of transactions that may be permitted or blocked. The account control dashboard 230 provides options for retailers, locations, and product types, but should not be limited to these options. The retailers option provides a button for adding retailers and a display box 210 of the retailers where a transaction is permitted. For example, a transaction request may be received at the transactional server for the account control system from Amazon, and the transaction request may be approved as the account holder has indicated that Amazon is an approved retailer for transactions. Similarly, should a transaction request be received at the transactional server from Home Depot, then the transaction request would be declined as Home Depot is not listed as an approved retailer by the account holder.

The locations option provides a button for adding locations and a display box 215 of the geographic locations, such as cities, where a transaction is permitted. The geographic permissions may identify an area, such as a city or state, where transactions are permitted. The geographic permissions may identify areas that transactions are not permitted, such as outside the state or outside the country. The product type option provides a button for adding product types and a display box 220 of the product types that may be purchased. For example, the user may want to limit purchases to essential items such as food, gas, and medical supplies. Similar restrictions may be made for services, such as indicating services of a mechanic or plumber is permitted, but a massage is not.

The application 125 may include a tab for recurring payments 240. The user may identify transactions which are recurring and indicate that the recurring transactions may be permitted. For example, a user may automatically pay their electricity bill every month. Under the tab for recurring payments 240 the user may identify the name of their electricity provider and indicate the frequency of the payment, such as monthly.

The account control dashboard 230 provides examples of options for permitting a transaction. The account control dashboard 230 may also present options for restricting use. For example, a similar retailers option may be presented where the user may identify retailers that are blocked from transactions and will result in a denial if a transaction is requested.

An account holder may identify regions or a geo-fence area for which transactions are permitted within. For example, the account holder may identify a region such as a metropolitan area (e.g., the greater Los Angeles area), a state (e.g., Colorado), or a regional area (e.g., New England states). Regions may be defined by country or include restrictions against transactions outside of the account holder's own country if they do not travel abroad. The geo-fenced regions may be time dependent. For example, the account holder may permit transaction for a region for a designated date range if the account holder is going on vacation.

The application 125 may provide the account holder with a map where the user may draw, either freehand or with selection shapes, the geo-fenced area where transactions may be permitted. For example, an account holder may frequently travel between Dallas and Houston, thus the account holder may draw an area that includes Dallas, Houston, and the highway in between the two cities.

The settings described in FIGS. 1 and 2 may be communicated to a transactional server, such as a server associated with the accounts of the user. The transactional server may be part of the account control system and may be operated by the account provider for managing transactions of the account holders. The transactional server may approve or decline requests for money, transactions, or requests for data. The approval may depend on factors such as an authentication of the requester and funds in the account the request is for. The approval may depend on the personal settings and preferences the user has provided, such as the settings found in the control dashboard 130 of the application 125.

A transaction request may be declined or not approved based on the parameters provided by the account holder through the account control dashboard 130. The account holder may request to be notified when a declined transaction request occurs. The account holder may provide an identifiable code or image to the account provider. Each notification for a declined transaction request may include the identifiable code or image as a way for the account holder to verify the source of the notification is the account provider and not a fraudulent source.

In an example, it may be reported that an information breach has occurred with a money or information transfer service. The account provider service may identify account holders who have added the transfer service as a permissible service and an active service for account holder's respective account. The account provider may automatically disable or set as inactive the transfer service for the identified account holders to prevent fraudulent transfers to occur based on the information breach. Similar steps may be taken when an information breach occurs with a retailer, the account provider may disable transactions for the retailer for account holders which had indicated the retailer was permissible.

The account control dashboard may be used with information services, such as email providers and health providers. The user may indicate which services may access their information, such as health records. Should an informational breach occur, such as for a health insurance provider, the access to the user's health information may automatically be suspended for the health insurance provider.

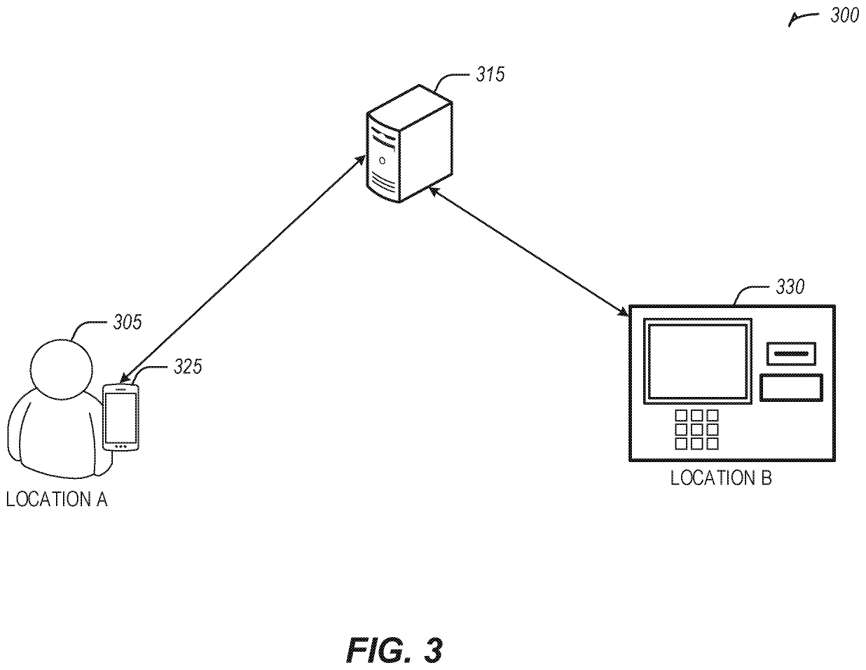

FIG. 3 is an example 300 of a situational condition for a transaction, in accordance with some embodiments. In addition to setting permissions for types of services or contextual data of the transaction, such as an amount limit or permissible retailer, the user may set situational conditions in the account control dashboard. For example, a user 305 may wish to limit withdrawals from an automatic teller machine (ATM) 330. As the user 305 may travel and not want to adjust the geographic location setting each time they are in a new location, the user 305 may provide a conditional setting based on the location of the user's mobile device 325.

The user 305 may indicate that an ATM 330 transaction may only be permitted when the mobile device 325 is in the same geographic location as the ATM 330. Through the application 125, the user 305 may allow for the application 125 to access geographical positioning system (GPS) of the mobile device 325 and provide the geographic location of the mobile device 325 to the transactional server 315.

For example, an ATM 330 at Location B may make a request to the transactional server 315 for a withdrawal from an account associated with user 305. The transactional server 315 may request the geographic location of the mobile device 325 associated with user 305. Using a sensor, such as a GPS, the mobile device 325 may provide its current geographic location to the transactional server 315. In the example 300, the mobile device 325 is in Location A while the ATM 330 is in Location B. The transactional server 315 may decline the withdrawal request from the ATM 330 as the location of the ATM 330 is not the same as the mobile device 325.

A machine learning model may be used to automatically determine settings for an account holder. A classifier model may receive transactional data for an account holder. The transactional data may be classified to identify common transactions and interactions that occur with the account and automatically generate conditional settings for transfers and transactions. A machine learning model may be trained using transactional data for an account holder identifying permissible and impermissible transaction parameters. The trained model may be used to determine if a transaction request should be allowed if the requester of the transaction is unknown.

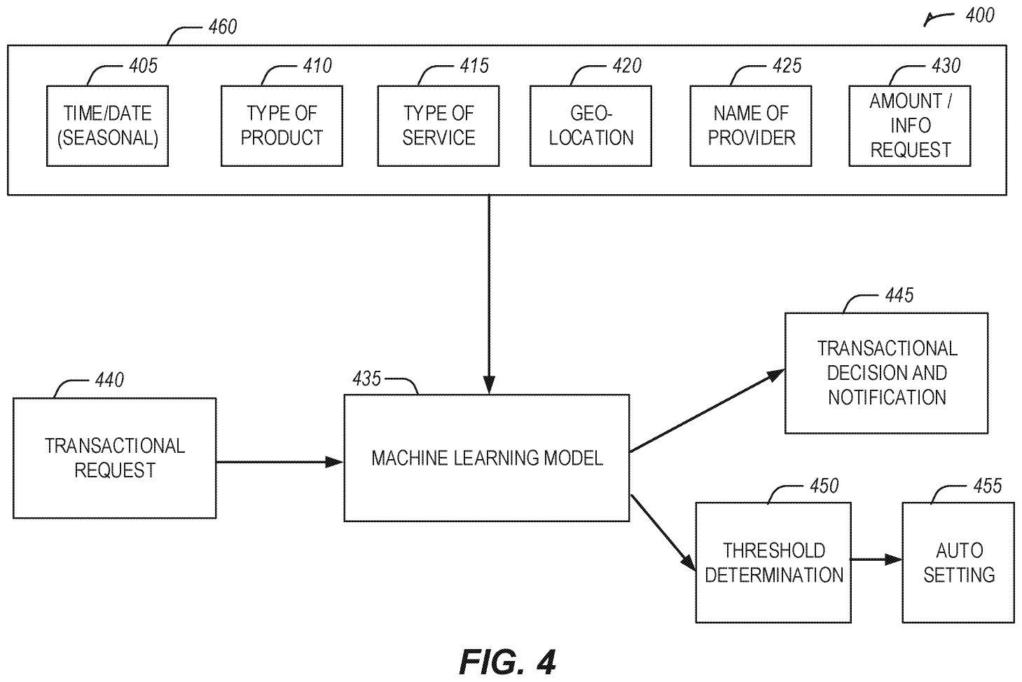

FIG. 4 illustrates an example 400 of a machine learning model 435 for transactional conditions, in accordance with some embodiments. A machine learning model 435 may be trained using a set of transactional data 460 for an account holder. The transactional data 460 may include contextual data and specifics for each transaction of the set of transactional data 460.

The transactional data 460 may include time and date information 405. The time and date information 405 may identify the specific time and date of a transaction, as well as the day of the week, general time of day, such as morning or evening, and seasonal information, such as the holidays. The transactional data 460 may include product information 410. The product information 410 may identify a type of product, such as clothes, food, or electronics, or may identify a specific product, such as a mobile phone by brand name. The transactional data 460 may include service information 415. The service information 415 may identify a service type for the transaction, such as a vehicle repair or home painting.

The transactional data 460 may include geographic location information 420. The geographic location information 420 may include the location of the transaction request origination, such as the retailer location or a person requesting a money transfer. The geographic location information 420 may include the headquarters for an online retailer.

The transactional data 460 may include provider name information 425. The provider name information may include the name of a retailer, the name of the transfer service, or the name of the requester, being either a name of a person or name of a company. The transactional data 460 may include an amount or information requested 430. For a purchase or financial transfer, the amount being requested in the transaction may include the amount requested. For an informational query or transfer, the data being requested may be identified, such as a person's health records for a time period.

The transactional data 460 may be used to train a machine learning model 435. The machine learning model 435 may be a classifier model. The classifier model may classify each of the transactions based on the information included in the transactional data 460, such as time and date information 405, product information 410, service information 415, geographic location information 420, provider name information 425, and amount or information requested 430.

The classification and the transactions of each classification may be analyzed to identify patterns or frequencies of the account holder. A threshold determination 450 may be used to identify classifications which include a number of transactions which exceed a threshold number of transactions. For example, a threshold may be set at twenty transactions as indicative of a pattern. The classifier model may classify thirty transactions as purchasing a coffee between 9:00 AM and 10:00 AM on Wednesdays, thus as this exceeds the threshold, a pattern is identified for the user.

The threshold may be a percentage of transactions in the classification to the total number of transactions. For example, the percentage threshold may be set to 10%. Of the classifications identified, should one of the classifications include a number of transactions that is greater than the percentage threshold of 10% of the total number of classified transactions, then a pattern may be identified for that classification.

The threshold determination 450 may identify classifications that exceed a threshold and based on this identification, an automatic setting 455 may be provided to the account holder and added to the account control dashboard 130. For example, if the account holder frequently uses a money transfer service to send funds to their friend Susan through Transfer Service A, then a setting may be automatically added to the account control dashboard 130 to permit fund transfers to Susan using Transfer Service A. The classifier model and the threshold determination may be used to identify common or recurring interactions for the account holder so that the account holder does not have to manually input each of these permission settings.

The machine learning model may be trained with the transactional data 460, where each transaction of the transactional data is labeled as permissible or impermissible (e.g., allow or deny). Based on the training, the machine learning model 435 may be used to determine if a request should be permitted if an explicit setting does not exist based on the contextual data of the request. For example, an account holder may purchase a coffee from Coffee Shop A each morning, thus Coffee Shop A is approved for transactions. One morning, the account holder instead purchases a coffee from Coffee Shop B. Attempting to purchase the coffee is a transactional request 440 that is provided to the trained machine learning model 435. While Coffee Shop B is not specifically approved for transactions, based on the similar transactional data of the time of day and type of purchase, the machine learning model 435 may determine a transactional decision and notification 445.

In a second example, an account holder may occasionally make purchases under $100 from an electronics chain at Location A near their home. A transactional request 440 may be received from the electronics chain, but it is for $2000 at Location B that is on the other side of town. The machine learning model 435 may determine to decline this request and provide a transactional decision and notification 445 to the electronics chain and account holder. This determination may be made by the machine learning model 435 as the account holder does make purchases at the electronics chain, but the purchase amount and location are uncharacteristic for the account holder and thus it may be a fraudulent transaction request. Of the contextual data provided for the request, too many aspects of the transaction are uncharacteristic for the account holder.

The transaction data 460 and transaction history for an account holder may be monitored to identify automatic settings to provide for the account holder. For example, an account holder may purchase a plane ticket to take a trip. This transaction may include plane ticket data such as the departing and return dates, as well as the destination. Based on the plane ticket data, a temporary transaction permission setting may be automatically generated for the destination location and the time period between the departing and return dates.

When the machine learning model 435 may be used to determine if a request should be permitted if an explicit setting does not exist based on the contextual data of the request, the user may employ different options. As described in the examples above, the user may permit the machine learning model 435 to automatically approve or reject transactions. The user may instead request the account control system to notify the user of transactions that are not part of the routine for the user to approve or deny the transaction. The account control system may provide the user with an option to opt out of any transaction that is not part of the user's routine.

The machine learning model 435 may identify routines of the user, such as the example of purchasing a coffee from Coffee Shop A each morning. The user may then set parameters for this routine, such as a limit on the transaction amount or permitting only transactions from Coffee Shop A. Based on the identified routine, the user may be presented with an option to restrict transactions to only the identified routine transaction and disallow any other transactions at the routine time. For example, transactions at Coffee Shop A between 9:00 AM and 10:00 AM may be identified as the routine. These transactions may be permitted, but the user may indicate any other transaction at this time may not be permitted.

The account holder may choose to link their personal social media accounts to the account associated with the account control system. The posts and interactions of the account holder on social media may be analyzed similarly to the transaction history. For example, an account holder may post to a picture of themselves while on vacation to their social media account and identify their vacation location. However, the account holder did not identify the vacation location as a permissible location for transactions. The account control system may automatically generate a setting to allow transactions in the vacation location based on identifying the account holder is in the vacation location from their social media postings. Permission settings may be automatically generated based on the things that the account holder has “liked” on social media. For example, if the account holder has “liked” the restaurant Burgers N Fries, then a permission setting may be automatically generated for purchases at Burgers N Fries.

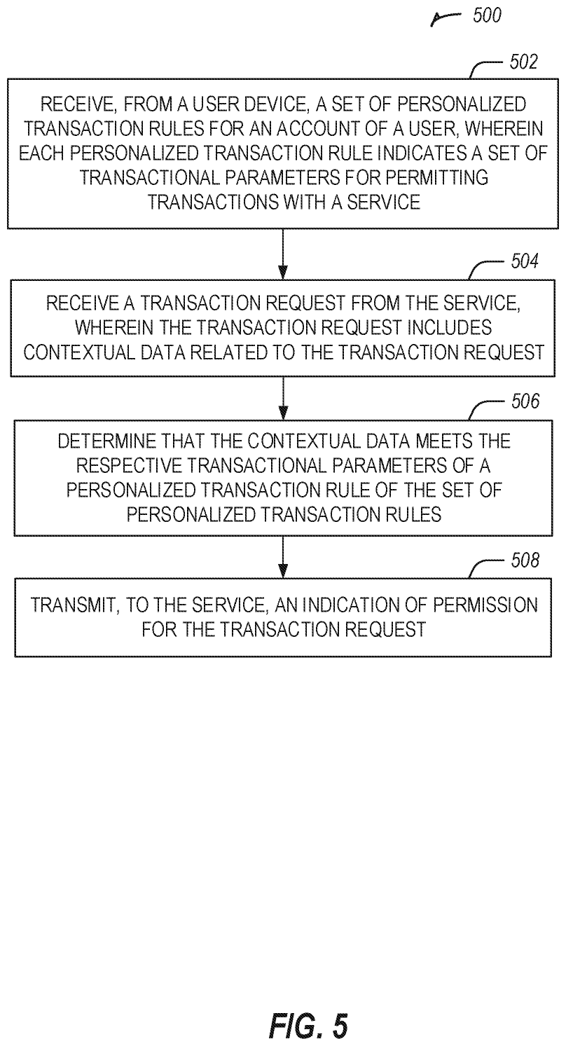

FIG. 5 illustrates a flowchart showing a technique 500 for managing access to personal account data, in accordance with some embodiments. The technique 500 includes an operation 502 to receive from a user device, a set of personalized transaction rules for an account of a user. Each personalized transaction rule may indicate a set of transactional parameters for permitting transactions with a service. As examples, permission may be for the release of information about the user or the completion of a financial transaction such as a purchase or transfer of funds. A transactional parameter may include one of a transaction amount limit, a geofenced area, a time period limitation, a recipient limit, or a goods type limitation

The set of personalized transaction rules may be automatically generated based on data of previous transactions associated with the account. The personalized transaction rules may be based on the habits found in the previous transactions, such as locations where purchases are commonly made or data that the user frequently shares or does not share.

The technique 500 may further include an operation, in response to receiving the set of personalized transaction rules, to transmit, to the user device, a confirmation including a unique identifier selected by the user. The unique identifier is one of an image, a code, or a phrase. For example, the user may select a picture of their dog. The account control system may transmit a confirmation of receiving the personalized transaction rules to the user and include the picture of the user's dog. Including the picture helps the user verify the authenticity of the communication from the account control service.

A personalized transaction rule may indicate a user data sharing level for the service. For example, the user may not trust the practices of Service A and indicates with a personalized transaction rule that only public information such as name and address may be shared with Service A. The technique 500 may further include an operation to transmit user data, to the service, based on the user data sharing level.

The technique 500 includes an operation 504 to receive a transaction request from the service. The request may include contextual data related to the request. The contextual data may include at least one of a transactional amount, a geographic location, a service name or identifier, a time stamp, or a recipient name.

The technique 500 includes an operation 506 to determine that the contextual data meets the respective transactional parameters of a personalized transaction rule of the set of personalized transaction rules. The technique 500 may further include an operation to train a machine learning model with the set of personalized transaction rules. For the training, each personalized transaction rule is labeled as permissible or impermissible. The technique 500 may further include an operation to use the machine learning model to determine the transaction request from the service is permitted

The technique 500 includes an operation 508 to transmit, to the service, an indication of permission for the transaction request.

The technique 500 may further include an operation to receive a set of transactional data for transactions with the account. The technique 500 may further include an operation to train a classifier model with the set of transactional data. The technique 500 may further include an operation to determine a set of classifications of the transactional data using the classifier model. The technique 500 may further include an operation to automatically create a new personalized transaction rule for the account based on a classification of the set of classifications.

The technique 500 may further include an operation to receive a set of transactional data for transactions with the account. A subset of the transactional data may be transactions with a subscription service. The technique 500 may further include an operation to create a new personalized transaction rule for the subscription service. A subscription service may be any type of transaction that occurs on a periodic basis, such a monthly bill pay for electricity or rent.

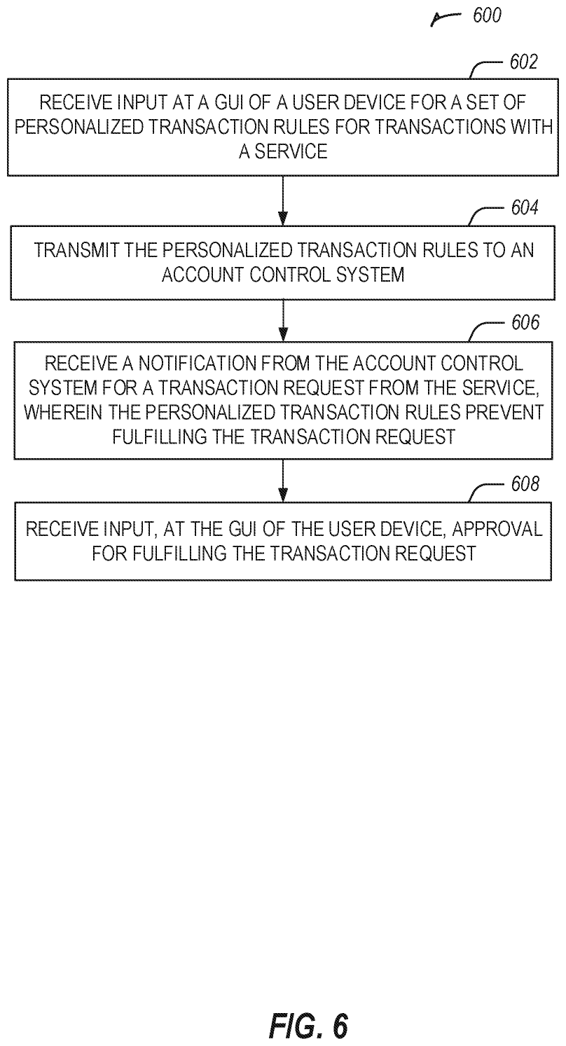

FIG. 6 illustrates a flowchart showing a technique 600 for managing access to personal account data, in accordance with some embodiments. The technique 600 includes an operation 602 to receive input at a GUI of a user device for a set of personalized transaction rules for transactions with a service. A user may input through an application on their device a set of personalized transactions rules for how their personal accounts may interact with services. The rules may be unique for each service. Each personal account may have different types of rules. For example, the rules for a transactions with a bank account may differ from rules with a health care account. A personalized transaction rule of the set of personalized transaction rules may indicate a user data sharing level for the service.

The technique 600 includes an operation 604 to transmit the personalized transaction rules to an account control system. The account control system may implement the operations of technique 500.

The technique 600 includes an operation 606 to receive a notification from the account control system for a transaction request from the service. The personalized transaction rules may provide approval for the transaction request or may prevent fulfilling the transaction request. The transaction request may include contextual data. The contextual data of the transaction request may be evaluated with the personalized transaction rules to determine fulfilling the transaction request. The contextual data may include a transactional amount, a geographic location, a service name or identifier, a time stamp, or a recipient name.

The notification may include a unique identifier selected by the user. The unique identifier may be an image, a code, or a phrase. The unique identifier may used to by the user to verify the authenticity of the notification. A user may receive fraudulent notifications in an attempt to gain personal information or passwords. The unique identifier may help prevent the user from being fooled by a fraudulent notification.

The technique 600 includes an operation 608 to receive input, at the GUI of the user device, approval for fulfilling the transaction request. The user may receive the notification that the transaction requests was not fulfilled. The user may decide that the transaction request should be authorized or fulfilled and may provide direct approval through the GUI to fulfill the transaction request.

The technique 600 may further include an operation to receive, at the user device, a generated personalized transaction rule. The generated personalized transaction rule may be automatically generated based on data of previous transactions. The generated personalized transaction rule may be generated from a machine learning model. The machine learning model may identify trends, habits, or common practices of the user through the data of the previous transactions. The generated personalized transaction rules may then be automatically implemented or transmitted to the user device for approval by the user.

The technique 600 may further include an operation to receive input, at the GUI of the user device, approval or denial of the generated personalized transaction rule. The user may want final authorization of the generated personalized transaction rule. For example, based on the user's previous transactions, it may be determined the user buys cigarettes on Friday afternoon, and thus a new personalized transaction rule is generated to allow the purchase of cigarettes on Friday afternoon. However, the user has decided to quit smoking, and so the user does not approve the new generated personalized transaction rule.

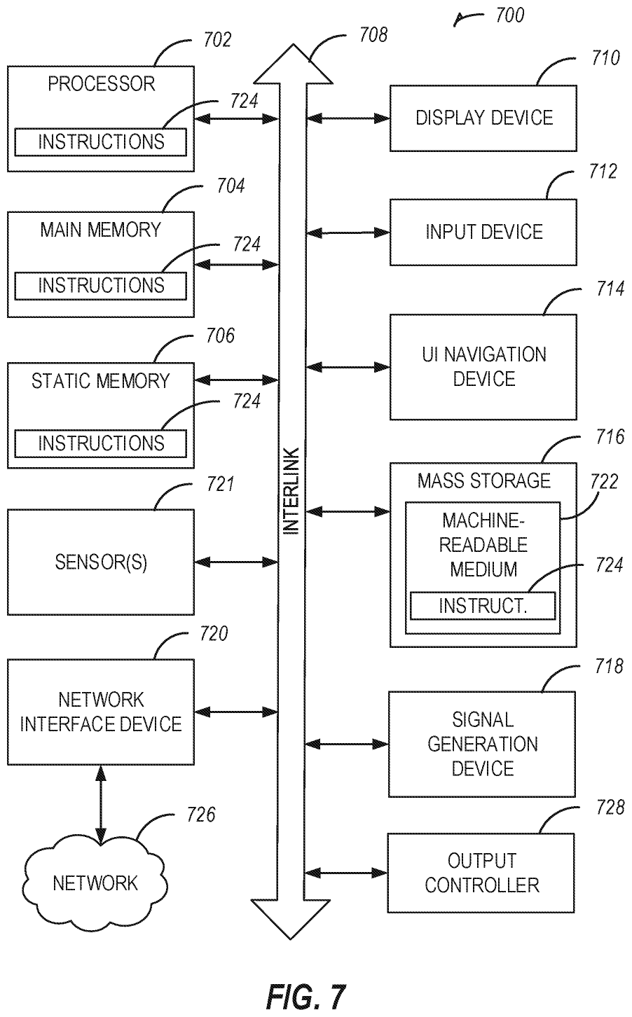

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 700 may include a hardware processor 702 (e.g., a central processing unit (CPU), a graphics processing unit (GPU), a hardware processor core, field programmable gate array (FPGA), or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or used by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SEM); multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A method for managing access to personal account data, comprising:
receiving, from a user device, a set of personalized transaction rules for an account of a user, wherein each personalized transaction rule indicates a set of transactional parameters for permitting transactions with a service;
receiving a transaction request from the service, wherein the transaction request includes contextual data related to the transaction request;
determining that the contextual data meets the respective transactional parameters of a personalized transaction rule of the set of personalized transaction rules; and
transmitting, to the service, an indication of permission for the transaction request.

2. The method of claim 1, wherein the set of personalized transaction rules are automatically generated based on data of previous transactions associated with the account.

3. The method of claim 1, wherein a transactional parameter includes one of a transaction amount limit, a geofenced area, a time period limitation, a recipient limit, or a goods type limitation.

4. The method of claim 1, wherein the contextual data includes at least one of a transactional amount, a geographic location, a service name or identifier, a time stamp, or a recipient name.

5. The method of claim 1, further comprising:
receiving a set of transactional data for transactions with the account;
training a classifier model with the set of transactional data;
determining a set of classifications of the transactional data using the classifier model; and
automatically creating a new personalized transaction rule for the account based on a classification of the set of classifications.

6. The method of claim 1, further comprising:
training a machine learning model with the set of personalized transaction rules, wherein each personalized transaction rule is labeled as permissible or impermissible; and
using the machine learning model to determine the transaction request from the service is permitted.

7. The method of claim 1, further comprising:
receiving a set of transactional data for transactions with the account, wherein a subset of the transactional data are transactions with a subscription service; and
creating a new personalized transaction rule for the subscription service.

8. The method of claim 1, further comprising:
in response to receiving the set of personalized transaction rules, transmitting, to the user device, a confirmation including a unique identifier selected by the user.

9. The method of claim 8, wherein the unique identifier is one of an image, a code, or a phrase.

10. The method of claim 1, wherein a personalized transaction rule of the set of personalized transaction rules indicates a user data sharing level for the service.

11. The method of claim 10, further comprising transmitting user data, to the service, based on the user data sharing level.

12. A system for managing access to personal account data, comprising:
at least one processor; and
memory including instructions that, when executed by be at least one processor, cause the at least one processor to:
receive, from a user device, a set of personalized transaction rules for an account of a user, wherein each personalized transaction rule indicates a set of transactional parameters for permitting transactions with a service;
receive a transaction request from the service, wherein the transaction request includes contextual data related to the transaction request;
determine that the contextual data meets the respective transactional parameters of a personalized transaction rule of the set of personalized transaction rules; and
transmit, to the service, an indication of permission for the transaction request.

13. The system of claim 12, wherein the set of personalized transaction rules are automatically generated based on data of previous transactions associated with the account.

14. The system of claim 12, wherein a transactional parameter includes one of a transaction amount limit, a geofenced area, a time period limitation, a recipient limit, or a goods type limitation.

15. The system of claim 12, wherein the contextual data includes at least one of a transactional amount, a geographic location, a service name or identifier, a time stamp, or a recipient name.

16. The system of claim 12, wherein a personalized transaction rule of the set of personalized transaction rules indicates a user data sharing level for the service.

17. At least one non-transitory machine-readable medium including instructions for managing access to personal account data that, when executed by at least one processor, cause the at least one processor to perform operations to:
receive, from a user device, a set of personalized transaction rules for an account of a user, wherein each personalized transaction rule indicates a set of transactional parameters for permitting transactions with a service;
receive a transaction request from the service, wherein the transaction request includes contextual data related to the transaction request;
determine that the contextual data meets the respective transactional parameters of a personalized transaction rule of the set of personalized transaction rules; and
transmit, to the service, an indication of permission for the transaction request.

18. The at least one non-transitory machine-readable medium of claim 17, wherein the set of personalized transaction rules are automatically generated based on data of previous transactions associated with the account.

19. The at least one non-transitory machine-readable medium of claim 17, wherein a transactional parameter includes one of a transaction amount limit, a geofenced area, a time period limitation, a recipient limit, or a goods type limitation.

20. The at least one non-transitory machine-readable medium of claim 17, wherein the contextual data includes at least one of a transactional amount, a geographic location, a service name or identifier, a time stamp, or a recipient name.
